(19) United States
(12) Patent Application Publication
(10) Pub. No.: US 2026/0059236 A1
(43) Pub. Date: Feb. 26, 2026

(54) SMART SPEAKER IN-CEILING ADAPTOR TECHNOLOGY AND POWER SYSTEM

(71) Applicant: Intelligent Systems LLC, Carmel, IN (US)

(72) Inventors: Stephe Blansette, Carmel, IN (US); Keenan Hecht, Carmel, IN (US); Barry Moffitt, Carmel, IN (US)

(21) Appl. No.: 17/900,479

(22) Filed: Aug. 31, 2022

Related U.S. Application Data
(60) Provisional application No. 63/239,502, filed on Sep. 1, 2021.

(51) Int. Cl. H04R 3/00; H04R 1/02

(52) U.S. Cl. CPC H04R 3/00; H04R 1/021; H04R 2201/021; H04R 2420/09

(57) ABSTRACT

A speaker system, including an enclosure, a speaker positioned in the enclosure, an AC voltage source, a step-down voltage converter operationally connected to the AC voltage source, an AC to DC converter operationally connected to the step-down voltage converter, and a USB power delivery controller operationally connected to the AC to DC converter. The USB power delivery controller is operationally connected to the speaker.

### BACKGROUND

In residential, commercial, and/or industrial environments-in-ceiling (or in-wall) low voltage speaker wire may exist with or without a high voltage source (such as an AC power bus)—which could be utilized to power smart devices by converting AC power to low voltage per negotiated power standards so that smart devices using USB-C low voltage (or similar) could be connected without running additional high voltage lines throughout the environment. For industrial environments the system enables smart devices to be connected to high voltage AC from DIN rails (or similar), as well as standard power outlets. Further, the system enables smart devices (such as smart speakers like the Apple HomePod mini, Google Nest mini, Amazon Echo, etc.) to be hidden in the ceiling or in-wall in what looks like a typical recessed speaker speaker—rather than placing the smart speaker on a tabletop surface.

### SUMMARY

One of more devices, systems, methods may implement one or more techniques for capturing AC power from an outlet or DIN rail-like source, translate into DC voltage over existing speaker wire (or other low voltage wire) in walls / ceilings to enable smart devices to be powered using industry standard low voltage schemes, such as but not limited to USB-C. Further, the system utilizes an existing opening (such as an in-wall or in-ceiling speaker opening) to house a smart speaker (or other DC power device) while still allowing interaction with the device (music playback, conference calls, verbal commands, etc.).

The system can be used in residential (e.g. home), commercial, industrial, military, and/or potentially any site which could benefit by translating high voltage AC into low voltage DC to run over existing low voltage conductors without needing to run new high voltage lines and “hide” smart devices in existing in-wall cavities.

In some embodiments, the existing speaker wire may be operationally connected to a DC power supply or AC to DC converter, with or without making use of the speaker enclosure.

### BRIEF DESCRIPTION OF THE DRAWINGS

The embodiment and other features, advantages and disclosures contained herein, and the manner of attaining them, will become apparent and the present disclosure will be better understood by reference of the following description of various examples of the present disclosure taken in conjunction with the accompanying drawings, wherein.

FIG. 1. Is a system diagram of the power translation to DC over existing (or new) in-wall low voltage conductors with a smart device placed in a wall cavity covered by a speaker grill. This could also be used to pass law voltage (12v-245v as an example) to a remote location and then provide USB negated power at the end point.

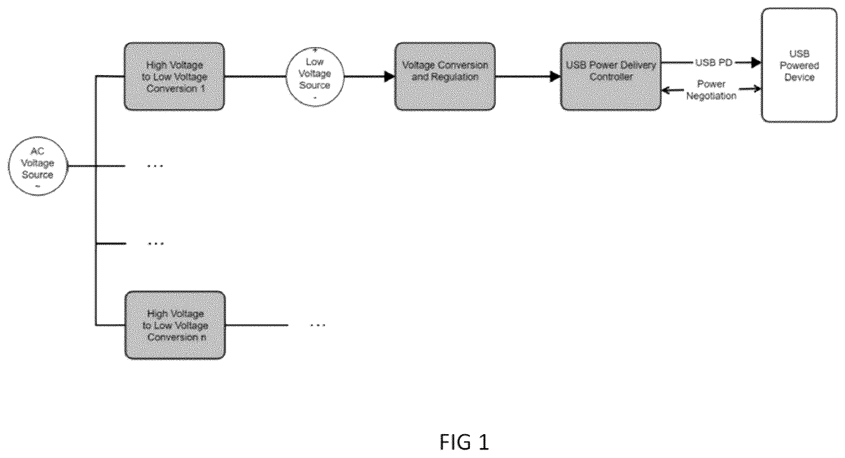

FIG. 2 illustrates an example of using an in-wall speaker enclosure to house and power a smart device. This utilizes existing “speaker wire” (16/2 gauge wire as an example) to carry power to the device in the enclosure

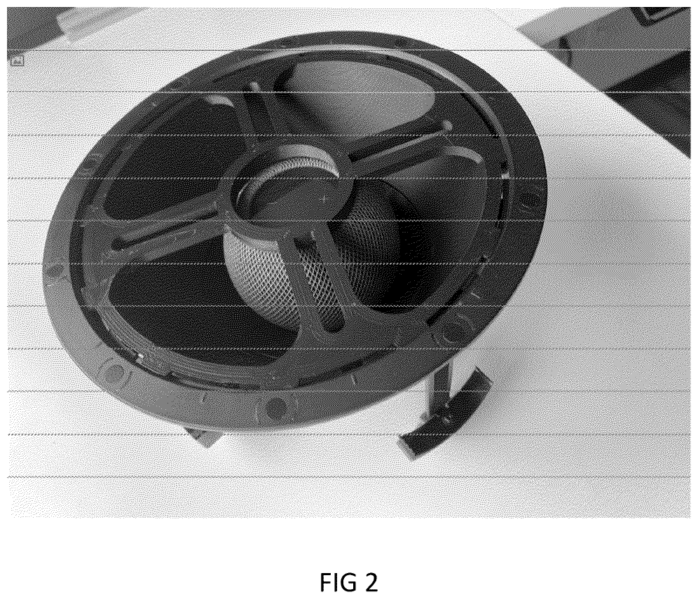

FIG. 3 illustrates a model of the system which houses and powers a smart device using existing low voltage wiring in a residence. These can be (but are not limited to) apple home pod mini's, google mini, amazon Alexa devices etc. We can make both in wall and in ceiling enclosure brackets for any type of device or location.

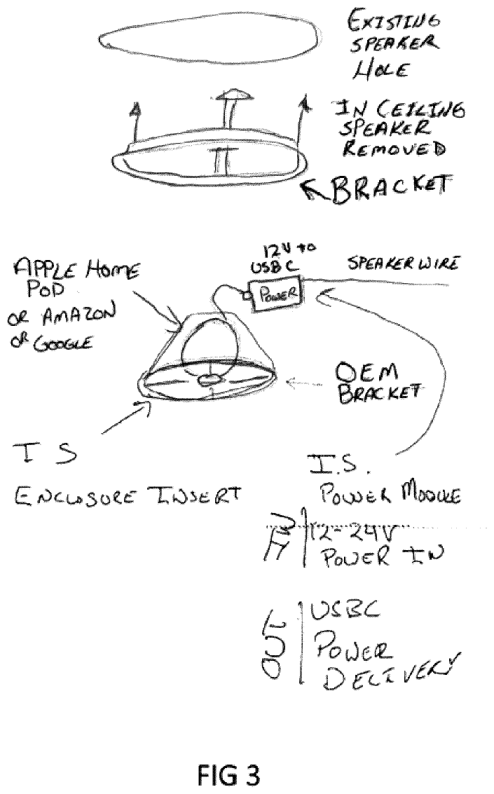

FIG. 4 illustrates custom brackets for use with the disclosed smart speaker system.

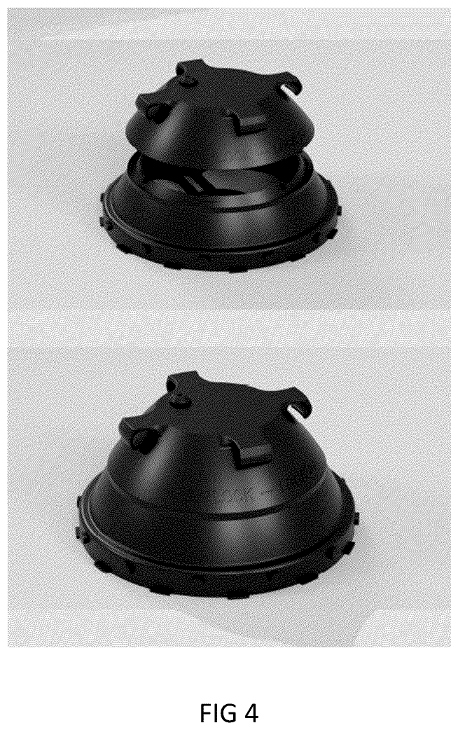

What is claimed is:

1. A speaker system, comprising:
an enclosure;
a speaker positioned in the enclosure;
an AC voltage source;
a step-down voltage converter operationally connected to the AC voltage source;
an AC to DC converter operationally connected to the step-down voltage converter;
a USB power delivery controller operationally connected to the AC to DC converter;
wherein the USB power delivery controller is operationally connected to the speaker.
